(19) United States
(12) Patent Application Publication
(10) Pub. No.: US 2022/0327572 A1
(43) Pub. Date: Oct. 13, 2022

(54) ADVERTISEMENT DISTRIBUTION GUARANTEE APPARATUS, ADVERTISEMENT DISTRIBUTION GUARANTEE METHOD, AND COMPUTER-READABLE RECORDING MEDIUM

(71) Applicant: NEC Corporation, Minato-ku, Tokyo (JP)

(72) Inventors: Sanami NAKAGAWA, Tokyo (JP); Keisuke KAJIGAYA, Tokyo (JP)

(73) Assignee: NEC Corporation, Minato-ku, Tokyo (JP)

(21) Appl. No.: 17/641,023

(22) PCT Filed: Sep. 30, 2019
(86) PCT No.: PCT/JP2019/038641

§ 371 Date: Mar. 7, 2022

(51) Int. Cl. G06Q 30/02; H04L 9/32; H04L 9/00

(52) U.S. Cl. CPC G06Q 30/0244; G06Q 30/0277; H04L 9/3247; H04L 9/50

(57) ABSTRACT

An advertisement distribution guarantee apparatus 10, includes; a viewing certificate generation unit 11 that causes a viewer terminal to generate a viewing certificate for a viewed advertisement content on condition that the advertisement content is viewed on the viewer terminal; a viewing certificate recording unit 12 that makes the generated viewing certificate visible to the advertiser of the advertisement content and causes the viewer terminal to record the generated viewing certificate in a blockchain database.

### TECHNICAL FIELD

The present invention relates to an advertisement distribution guarantee apparatus and an advertisement distribution guarantee method, and further relates to a computer-readable recording medium in which a program for executing these apparatus and method is recorded.

### BACKGROUND ART

In recent years, advertisements have been distributed in Web services and the like provided to users on the Web. For example, in a video distribution service such as YouTube (registered trademark), advertising content is distributed before and during viewing of a video. Further, in such advertisement distribution by the video distribution service, t h e advertisement fee is distributed to the distribution service provider and the video creator, youtuber, etc., according to the number of times the advertisement is distributed.

However, at present, there is no mechanism for the advertiser who pays the advertisement fee, the video creator, etc. to confirm whether or not the advertisement content is actually delivered to the viewers. The number of times the advertisement content is delivered is confirmed only by the report from the advertisement distribution company that is a subject distributing the advertisement.

However, the viewer who receives the advertisement may use an ad blocking function or the like that blocks the advertisement. In this case, the number of times the advertisement is delivered is counted, but the advertisement is not actually delivered. In addition, there is a possibility that the advertisement distribution company that distributes the advertisement falsely reports the number of times the advertisement is distributed by exploiting the fact that the advertiser and the video creator cannot confirm the number of times the advertisement is distributed. There is a case where a false declaration was actually made (see Non-Patent Document 1).

Therefore, an advertisement distribution management system using blockchain technology has been proposed in order to manage the regular number of such advertisement distributions without falsification (see, for example, Non-Patent Document 2).

### LIST OF RELATED ART DOCUMENTS

### Non-Patent Document

Non-Patent Document 1: “Dentsu scrutinizes digital advertising problems, fraudulently reaches 110 million yen”, [online], Jan. 17, 2017, ITmedia Business ON LINE, [Search on Sep. 19, 2019], Internet <URL: https: //www.itmedia.co.jp/business/articles/1701/17/news142.html>
Non-Patent document 2: “Started Japan's first demonstration experiment to make digital advertising effect transparent by utilizing blockchain”, [online], Apr. 25, 2017, D. A. Consortium, [Search on Sep. 19, 2019], Internet <URL: https//m.dac.co.jp/sp/press/2017/20170424 blockchain

### SUMMARY OF INVENTION

### Problems to be Solved by the Invention

However, one of the features of blockchain technology is that it is resistant to tampering with the registered data, but the content of the data is not guaranteed. Therefore, even if the advertisement distribution management system disclosed in Non-Patent Document 2 is introduced, when the advertisement distribution side writes data to the blockchain, the advertisement distribution side can make a false report.

That is, even if the advertisement distribution management system disclosed in Non-Patent Document 2 is used, it is difficult to solve the problem that “it cannot be guaranteed to the advertiser that the advertisement content is distributed on the Web service”.

An example object is to solve the above problem, and to provide an advertisement distribution guarantee apparatus, an advertisement distribution guarantee method, and a computer-readable recording medium that enable the advertiser to confirm the advertisement viewing history while suppressing the falsification of the advertisement viewing history in the distribution of the advertisement content on the Web.

### Means for Solving the Problems

In order to achieve the above-described object, a advertisement distribution guarantee apparatus according to an example aspect of the invention includes:

a viewing certificate generation unit that causes a viewer terminal to generate a viewing certificate for a viewed advertisement content on condition that the advertisement content is viewed on the viewer terminal,

a viewing certificate recording unit makes the generated viewing certificate visible to the advertiser of the advertisement content and causes the viewer terminal to record the generated viewing certificate in a blockchain database.

In addition, in order to achieve the above-described object, an advertisement distribution guarantee method according to an example aspect of the invention includes:

(a) causing a viewer terminal to generate a viewing certificate for a viewed advertisement content on condition that the advertisement content is viewed on the viewer terminal,

(b) making the generated viewing certificate visible to the advertiser of the advertisement content and causing the viewer terminal to record the generated viewing certificate in a blockchain database.

Furthermore, in order to achieve the above-described object, a computer readable recording medium according to an example aspect of the invention that includes a program recorded thereon, the program including instructions that cause a computer to carry out:

(a) a step of causing a viewer terminal to generate a viewing certificate for a viewed advertisement content on condition that the advertisement content is viewed on the viewer terminal,

(b) a step of making the generated viewing certificate visible to the advertiser of the advertisement content and causing the viewer terminal to record the generated viewing certificate in a blockchain database.

### Advantageous Effects of the Invention

As described above, according to the present invention, it is possible to enable the advertiser to confirm the advertisement viewing history while suppressing the falsification of the advertisement viewing history in the distribution of the advertisement content on the Web.

### BRIEF DESCRIPTION OF THE DRAWINGS

FIG. 1 is a block diagram schematically illustrating a configuration of an advertisement distribution guarantee apparatus according to a first example embodiment.

FIG. 2 is a block diagram specifically illustrating the configuration of the advertisement distribution guarantee apparatus according to the first example embodiment.

FIG. 3 is a flow diagram illustrating an operation of the advertisement distribution guarantee apparatus according to the first example embodiment.

FIG. 4 is a flow diagram illustrating an operation of an advertisement distribution guarantee apparatus according to the second example embodiment.

FIG. 5 is a block diagram illustrating an example of a computer that realizes the advertisement distribution guarantee apparatus according to the first and the second example embodiments.

### EXAMPLE EMBODIMENT

### Outline of the Invention

Currently, there is no way to confirm that the advertising content provided to the viewer was actually viewed by the viewer. Further, it is assumed that only the advertisement distributor, who has a merit in falsifying the data related to the performance of advertisement distribution, can register the data related to the performance of advertisement distribution. In this case, false data may be registered.

Therefore, in the present invention, the viewing certificate is created on the viewer side who has no merit in falsifying the data, and the viewing certificate is written in the blockchain database so that the advertisement distribution side cannot falsify. As a result, the reliability of the data regarding the performance of advertisement distribution is improved, and it is possible to provide the advertiser with a highly reliable history of advertisement distribution.

### First Example Embodiment

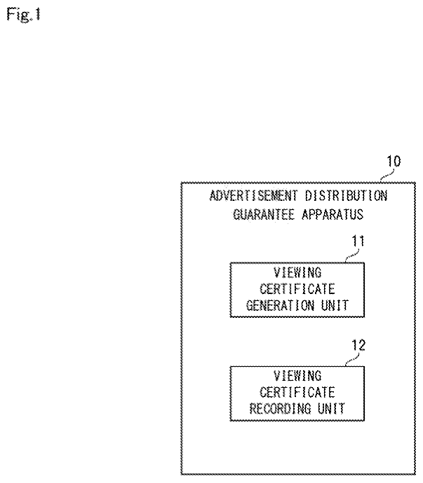

The following describes an advertisement distribution guarantee apparatus, an advertisement distribution guarantee method, and a program according to a first example embodiment with reference to FIGS. 1 to 3. It should be noted that the first example embodiment described below is for facilitating the understanding of the present invention and does not limit the present invention. That is, the present invention can be modified and improved without departing from the spirit thereof, and it goes without saying that the present invention includes an equivalent thereof. In particular, the screen design and layout described in the following description and drawings are merely examples and can be appropriately changed according to the intended use of the present invention, the user's request, and the like.

[Apparatus Configuration]

First, a schematic configuration of the advertisement distribution guarantee apparatus according to the first example embodiment will be described with reference to FIG. 1. FIG. 1 is a block diagram schematically illustrating a configuration of the advertisement distribution guarantee apparatus according to the first example embodiment.

The advertisement distribution guarantee apparatus 10 according to the first example embodiment shown in FIG. 1 is an apparatus guaranteeing that the advertisement content created by the advertiser has been distributed to the viewer. As shown in FIG. 1, the advertisement distribution guarantee device 10 includes a viewing certificate generation unit 11 and a viewing certificate recording unit 12.

The viewing certificate generation unit 11 causes a viewer terminal to generate a viewing certificate for the viewed advertisement content on condition that the advertisement content is viewed on the viewer terminal. Further, the viewing certificate recording unit 12 makes the generated viewing certificate visible to the advertiser of the advertisement content and causes the viewer terminal to record the generated viewing certificate in a blockchain database.

As described above, in the first example embodiment, when the viewer views the advertisement content, the advertisement distribution guarantee apparatus 10 causes the viewer terminal to generate the viewing certificate proving that fact. Further, the advertisement distribution guarantee apparatus 10 causes the viewer terminal to write to the blockchain, which is difficult to falsify, in a state where the advertiser can confirm the generated viewing certificate. Therefore, according to the first example embodiment, it is possible to enable the advertiser to confirm the advertisement viewing history while suppressing the falsification of the advertisement viewing history in the distribution of the advertisement content on the Web.

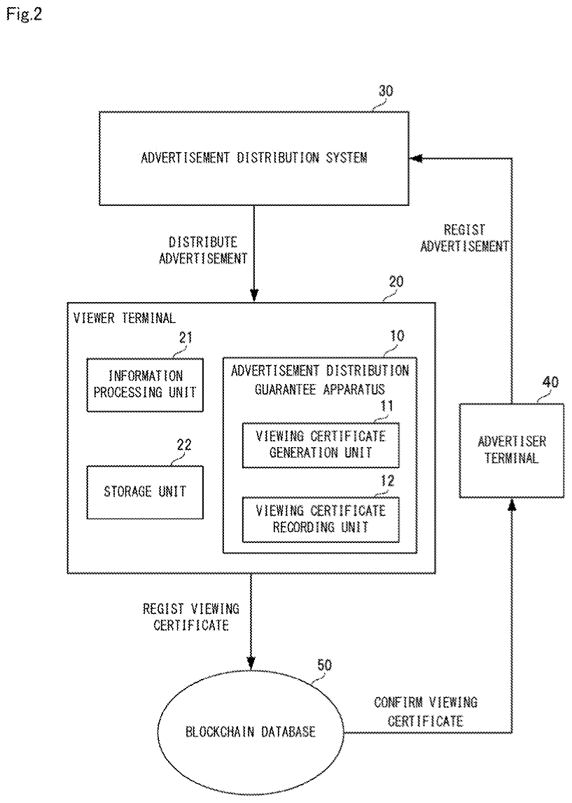

Subsequently, with reference to FIG. 2, the configuration of the advertisement distribution guarantee apparatus 10 according to the first example embodiment will be specifically described. FIG. 2 is a block diagram specifically illustrating the configuration of the advertisement distribution guarantee apparatus according to the first example embodiment.

As shown in FIG. 2, in the first example embodiment, the advertisement distribution guarantee apparatus 10 is constructed as a part of a terminal apparatus of the viewer (hereinafter referred to as “viewer terminal”) 20. Specifically, the advertisement distribution guarantee apparatus 10 is constructed by a program that operates on the operation system (OS) of the viewer terminal 20. This program will be described later.

Further, as shown in FIG. 2, in the first example embodiment, the viewer terminal 20 for constructing the advertisement distribution guarantee apparatus 10 is connected to the advertisement distribution system 30 and the blockchain database 50 via network such as the internet.

The advertisement distribution system 30 receives and registers the advertisement content transmitted by the advertiser from the terminal device (hereinafter referred to as “advertiser terminal”) 40 of the advertiser. Further, the advertisement distribution system transmits the registered advertisement content to the viewer terminal 20 on the Web.

Further, the blockchain database 50 is a database constructed by a blockchain which is a distributed network. The blockchain database 50 collects some transactions occurring at each set time, generates a block of data called a block, and registers the collected transactions for each block. Then, each block contains the digest data of the entire block before that. The digest data is a hash value obtained by a hash function. Therefore, when a certain block is tampered with, the hash value of the entire block changes, and inconsistency occurs between the tampered block and the digest data of the next block. Therefore, it is difficult to falsify the data recorded in the blockchain database 50.

Further, as shown in FIG. 2, the viewer terminal 20 includes an information processing unit 21 and a storage unit 22 in addition to the advertisement distribution guarantee apparatus 10. Of these, the information processing unit 21 is constructed by a program that operates on the OS of the viewer terminal 20, similarly to the advertisement distribution guarantee apparatus 10. The information processing unit 21 generates and records the viewing certificate in response to an instruction from the advertisement distribution guarantee apparatus 10. The storage unit 22 is constructed by a storage device such as a memory provided in the viewer terminal 20.

Further, when the advertisement content is delivered from the advertisement distribution system 30, the information processing unit 21 acquires the delivered advertisement content and reproduces the acquired advertisement content, specifically, video data. As a result, the advertising content is displayed on the screen (not shown in FIG. 2) of the viewer terminal 20.

In the first example embodiment, the viewing certificate generation unit 11 determines that the advertising content has been viewed, for example, when the advertising content is displayed on the screen of the viewer terminal 20 as described above. Then, in this case, the viewing certificate generation unit 11 causes the information processing unit 21 of the viewer terminal 20 to generate the viewing certificate.

Specifically, the viewing certificate generation unit 11 generates a signature key (private key) and a corresponding verification key (public key). The viewing certificate generation unit 11 stores the private key in the storage unit 22 of the viewer terminal 20. Then, the viewing certificate generation unit 11 causes the information processing unit 21 of the viewer terminal 20 to generate a digital signature by using the private key. Next, when the advertisement content is viewed, the viewing certificate generation unit 11 causes the viewer terminal 20 to generate the viewing certificate for the viewed advertisement content and adds the abovementioned digital certificate to the generated viewing certificate.

In this case, the viewing certificate may be composed of information that can identify the viewed advertisement content. Examples of the viewing certificate include a combination of a hash value obtained from the viewed advertisement content, an identifier (advertisement ID), and time information for specifying the viewing time.

Further, in the first example embodiment, the viewing certificate recording unit 12 enables the advertiser (advertiser terminal 40) to acquire the verification key. Specifically, the viewing certificate recording unit 12 transmits the verification key to the advertiser terminal 40 and causes a public key infrastructure such as a PKI (Public Key Infrastructure) to guarantee the relationship between the viewer terminal 20 and the verification key. Then, the viewing certificate recording unit 12 causes the information processing unit 21 of the viewer terminal 20 to record the generated digital signature in the blockchain database 50.

Further, in the first example embodiment, the viewing certificate generation unit 11 causes the information processing unit 21 of the viewer terminal 20 to generate the digital signature each time a single advertisement content is delivered. Further, the viewing certificate recording unit 12 causes the information processing unit of the viewer terminal 20 to record the digital signature in the blockchain database 50 each time a single advertisement content is delivered.

[Apparatus Operation]

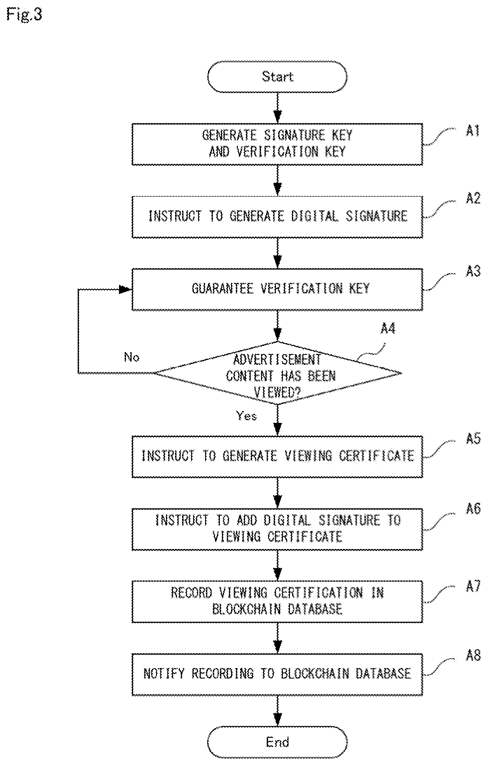

Next, the operation of the advertisement distribution guarantee apparatus 10 according to the first example embodiment will be described using FIG. 3. FIG. 3 is a flow diagram illustrating the operation of the advertisement distribution guarantee apparatus according to the first example embodiment. In the following description, FIGS. 1 and 2 will be referred to as appropriate. Further, in the first example embodiment, the advertisement distribution guarantee method is implemented by operating the advertisement distribution guarantee apparatus 10. Therefore, the following description of the operations of the advertisement distribution guarantee apparatus 10 applies to the advertisement distribution guarantee method according to the second example embodiment.

As shown in FIG. 3, the viewing certificate generation unit 11 first generates the private key and the corresponding verification key (public key). The viewing certificate generation unit 11 stores the private key in the storage unit 22 of the viewer terminal 20 (step A1).

Next, the viewing certificate generation unit 11 causes the information processing unit 21 of the viewer terminal 20 to acquire the private key stored in the storage unit 22 and generate the digital signature using the acquired private key (step). A2).

Next, to enable the advertiser (advertiser terminal 40) to acquire the verification key generated in step A1, the viewing certification recording unit 12 transmits the verification key to the advertiser terminal 40 and causes the public key infrastructure to guarantee the relationship between the viewer terminal 20 and the verification key (step A3).

Next, the viewing certificate generation unit 11 determines whether or not the advertisement content delivered from the advertisement distribution system 30 has been viewed on the viewer terminal 20 (step A4). For example, the viewing certificate generation unit 11 acquires a code executed by the information processing unit 21 of the viewer terminal 20, analyzes the acquired code, and determines whether or not the advertisement content is reproduced by the information processing unit 21.

As a result of the determination in step A4, when the advertisement content is not viewed on the viewer terminal 20, the viewing certificate generation unit 11 is in a standby state. After the set time has elapsed, the viewing certificate generation unit 11 executes step A4 again.

On the other hand, as a result of the determination in step A4, when the advertisement content is viewed on the viewer terminal 20, the viewing certificate generation unit 11 causes the information processing unit 21 of the viewer terminal 20 to generate the viewing certificate for the viewed advertisement content (step A5).

Specifically, when the generation of the viewing certificate is instructed, the information processing unit 21 calculates, for example, the hash value of the viewed advertisement content. The information processing unit 21 combines the calculated hash value, the identifier of the viewed advertisement content, and the time information for specifying the time of viewing as the viewing certificate.

Next, the viewing certificate generation unit 11 causes the information processing unit 21 of the viewer terminal 20 to add the digital signature generated in step A2 to the viewing certificate generated in step A5 (step A6).

Next, the viewing certificate recording unit 12 causes the viewer terminal 20 to record the viewing certification to which the digital signature by the viewer terminal 20 is added in step A5 in the blockchain database 50 (step A7).

After that, the viewing certificate recording unit 12 notifies the advertiser terminal 40 that the viewing certification is newly recorded in the blockchain database 50 (step A8).

When step A8 is executed, the advertiser obtains the verification key via the advertiser terminal 40 and accesses the blockchain database 50 to be able to confirm that own advertising content has been viewed. Further, since the viewing certificate recorded in the blockchain database 50 is signed by the viewer, the advertiser does not have to worry that the viewing certificate has been tampered with.

### Effect of the First Example Embodiment

As described above, according to the first example embodiment, it is possible to enable the advertiser to confirm the advertisement viewing history while suppressing the falsification of the advertisement viewing history in the distribution of the advertisement content on the Web.

Further, in the first embodiment, it is guaranteed that the viewing certificate is generated by the viewer using the private key which is the private key and the verification key which is the public key. The first example embodiment is not limited to this embodiment. In the first example embodiment, another means for guaranteeing that the viewing certificate is generated by the viewer may be used.

[Program]

It is sufficient that the program according to the first example embodiment be a program that causes a computer to execute steps A1 to A8 illustrated in FIG. 3. The advertisement distribution guarantee apparatus 10 and the advertisement distribution guarantee method according to the first example embodiment can be realized by installing this program in the computer and executing this program. In this case, a processor of the computer functions and performs processing as the viewing certificate generation unit 11 and the viewing certificate recording unit 12. Further, the computer in this case may be, for example, a computer constituting the viewer terminal or a computer different from the viewer terminal.

Also, the program according to the first example embodiment may be executed by a computer system constructed by a plurality of computers. In this case, for example, each computer may function as one of the viewing certificate generation unit 11 and the viewing certificate recording unit 12.

### Second Example Embodiment

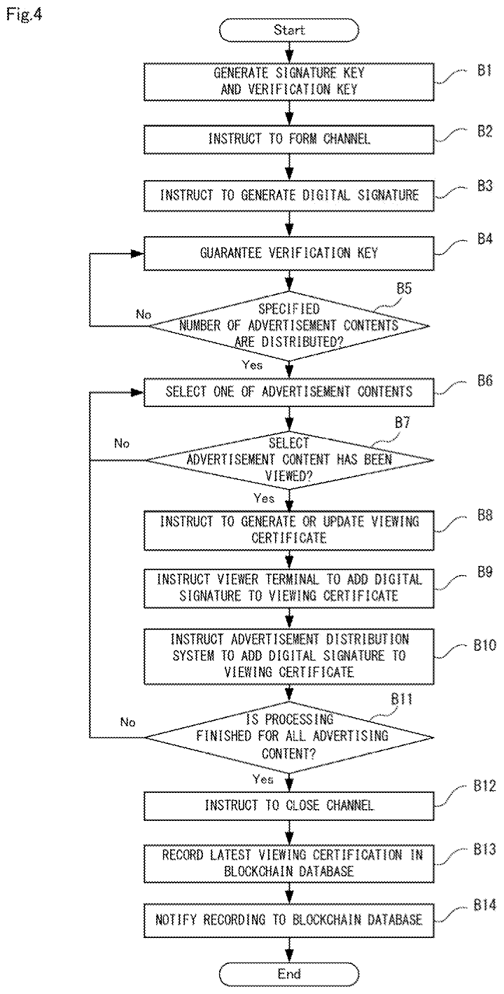

Next, following describes an advertisement distribution guarantee apparatus, an advertisement distribution guarantee method, and a program according to second example embodiment with reference to FIG. 4. It should be noted that the second example embodiment described below is for facilitating the understanding of the present invention and does not limit the present invention, as in the first example embodiment. That is, the present invention can be modified and improved without departing from the spirit thereof, and it goes without saying that the present invention includes an equivalent thereof. In particular, the screen design and layout described in the following description and drawings are merely examples and can be appropriately changed according to the intended use of the present invention, the user's request, and the like.

[Apparatus Configuration]

First, the advertisement distribution guarantee apparatus according to the second example embodiment has the same configuration as the advertisement distribution guarantee apparatus according to the first example embodiment shown in FIGS. 1 and 2. Therefore, in the following description, reference will be made to FIGS. 1 and 2.

However, in the second example embodiment, unlike the first example embodiment, when a plurality of advertisement contents is delivered from the advertisement distribution system 30, a process of bundling the plurality of advertisement contents is performed. In the second example embodiment, in this case, when any one of the plurality of advertisement contents is first viewed on the viewer terminal 20, the viewing certificate generation unit 11 causes the viewer terminal 20 to generate the viewing certificate with the digital signature attached for the first viewed advertising content. Further, when the remaining advertisement content is viewed on the viewer terminal 20, the viewing certificate generation unit 11 causes the viewer terminal 20 to update the viewing certificate each time the viewing is performed.

In the second embodiment, when a plurality of advertisement contents are distributed from the advertisement distribution system 30, the viewing certification recording unit 12 causes the viewer terminal 20 to record the latest viewing certification in the blockchain database 50.

Further, in the second example embodiment, the viewing certificate is digitally signed by the advertisement distribution system 30. The digital signature by the advertisement distribution system 30 is performed by the private key of the advertisement distribution system 30 itself. The advertisement distribution system 30 transmits the verification key corresponding to its private key to the advertiser terminal 40 and makes the public key infrastructure guarantee the relationship between itself and the verification key.

Further, in the second example embodiment, the viewing certificate generation unit 11 causes the viewer terminal 20 and the advertisement distribution system 30 to form a channel between them. More specifically, the channel formation used in off-chain technology is performed.

In this case, every time the viewer terminal 20 generates and updates the viewing certificate, the viewing certificate creating unit 11 also transmits the viewing certificate added the digital signature by the viewer terminal to the advertisement distribution system 30 via the formed channel. The viewing certificate creating unit 11 causes the advertisement distribution system 30 to add a digital signature to the viewing certificate. Further, as a result, the advertisement distribution system 30 returns a viewing certificate with a newly digital signature via the channel.

Further, the exchange of viewing certifications via such a channel is performed as many times as the number of the delivered advertisement contents when a plurality of advertisement contents is delivered from the advertisement distribution system 30. As a result, the viewing certificate is generated and updated, and each time, the viewer terminal 20 and the advertisement distribution system 30 generate the digital signature. After that, the viewing certificate recording unit 12 causes the viewer terminal 20 to record the latest viewing certification with the digital signatures of both in the blockchain database 50.

[Apparatus Operation]

Next, the operation of the advertisement distribution guarantee apparatus according to the second example embodiment will be described using FIG. 4. FIG. 4 is a flow diagram illustrating an operation of the advertisement distribution guarantee apparatus according to the second example embodiment. In the following description, FIGS. 1 and 2 will be referred to as appropriate. Further, in the second example embodiment, the advertisement distribution guarantee method is implemented by operating the advertisement distribution guarantee apparatus. Therefore, the following description of the operations of the advertisement distribution guarantee apparatus applies to the advertisement distribution guarantee method according to the second example embodiment.

As shown in FIG. 3, the viewing certificate generation unit 11 first generates the private key and the corresponding verification key (public key). The viewing certificate generation unit 11 stores the private key in the storage unit 22 of the viewer terminal 20 (step B1).

Next, the viewing certificate generation unit 11 causes the viewer terminal 20 and the advertisement distribution system 30 to form the channel between them (step B2).

Next, the viewing certificate generation unit 11 causes the information processing unit 21 of the viewer terminal 20 to acquire the private key stored in the storage unit 22 and generate the digital signature using the acquired private key (step B3).

Next, to enable the advertiser (advertiser terminal 40) to acquire the verification key generated in step B2, the viewing certification recording unit 12 transmits the verification key to the advertiser terminal 40 and causes the public key infrastructure to guarantee the relationship between the viewer terminal 20 and the verification key (step B4).

Next, the viewing certificate generation unit 11 determines whether or not a specified number (s) of advertisement contents are distributed from the advertisement distribution system 30 to the viewer terminal 20 (step B5).

As a result of the determination in step B5, when the specified number of advertisement contents are not distributed from the advertisement distribution system 30 to the viewer terminal 20, the viewing certificate generation unit 11 is in a standby state. After the set time has elapsed, the viewing certificate generation unit 11 executes step B5 again.

On the other hand, as a result of the determination in step B5, when the specified number of advertisement contents are distributed from the advertisement distribution system 30 to the viewer terminal 20, the viewing certificate generation unit 11 selects one of the advertisement contents from the distributed advertisement contents (step B6).

Next, the viewing certificate generation unit 11 determines whether or not the advertising content selected in step B6 has been viewed on the viewer terminal 20 (step B7).

As a result of the determination in step B7, when the advertisement content selected in step B6 is not viewed on the viewer terminal 20, the viewing certificate generation unit 11 executes step B6 again to select another advertisement content.

On the other hand, as a result of the determination in step B7, when the advertisement content selected in step B6 is viewed on the viewer terminal 20, the viewing certificate generation unit 11 causes the information processing unit 21 of the viewer terminal 20 to generate or update the viewing certificate of the viewed advertisement content (step B8).

Specifically, when the generation or update of viewing certificate is instructed, the information processing unit 21 calculates the hash value of the viewed advertisement content. When there is a viewing certificate generated before, the information processing unit 21 combines the hash value calculated earlier and the hash value calculated this time to obtain the latest hash value. Then, the information processing unit 21 combines the latest hash value, the list of identifiers of the advertisement contents viewed so far, and the time information for specifying the viewing time of each advertisement content as the viewing certification.

Next, the viewing certificate generation unit 11 causes the information processing unit 21 of the viewer terminal 20 to add the digital signature generated in step B3 to the viewing certificate generated in step B8 (step B9).

Next, the viewing certificate generation unit 11 transmits the viewing certificate generated in step B8 to the advertisement distribution system 30 via the channel and causes the advertisement distribution system 30 to add the signature to the viewing certificate (step B10).

When step B10 is executed, the advertisement distribution system 30 adds the digital signature to the transmitted viewing certificate with its own private key, and returns the viewing certificate with the newly added digital signature via the channel. Further, the advertisement distribution system 30 transmits the verification key corresponding to its private key to the advertiser terminal 40, and causes the public key infrastructure to guarantee the relationship between itself and the verification key.

Next, the viewing certificate generation unit 11 determines whether or not all the processes of steps B6 to B10 have been completed for all the specified number of advertisement contents determined to have been delivered in step B5 (step B11).

As a result of the determination in step B11, when all the processes of steps B6 to B10 have not been completed for all the specified number of advertisement contents, the viewing certificate generation unit 11 executes step B6 again and select another advertisement content.

On the other hand, as a result of the determination in step B11, when all the processes of steps B6 to B10 have been completed for all the specified number of advertisement contents, the viewing certificate generation unit 11 causes the viewer terminal 20 and the advertisement distribution system 30 to close the channel between them (step B12).

Next, the viewing certificate recording unit 12 causes the viewer terminal 20 to record the latest viewing certification with the digital signature added by both the viewer terminal 20 and the advertisement distribution system 30 in the blockchain database 50. (Step B13).

After that, the viewing certificate recording unit 12 notifies the advertiser terminal 40 that the viewing certification has been recorded in the blockchain database 50 (step B14).

When step B14 is executed, the advertiser obtains the verification key via the advertiser terminal 40 and accesses the blockchain database 50 to be able to confirm that own advertising content has been viewed. Further, since the viewing certificate recorded in the blockchain database 50 is signed by the viewer, the advertiser does not have to worry that the viewing certificate has been tampered with.

### Effect of the Second Example Embodiment

As described above, in the second example embodiment, as in the first example embodiment, it is possible to enable the advertiser to confirm the advertisement viewing history while suppressing the falsification of the advertisement viewing history in the distribution of the advertisement content on the Web. Further, in the second example embodiment, the viewing certification corresponding to the plurality of advertising contents is registered in the blockchain database 50, and the viewing certification is not registered for each advertising content. Therefore, according to the second example embodiment, it is possible to suppress an increase in the number of transactions, and it is possible to reduce the processing load on the advertisement distribution guarantee apparatus 10 and the processing load on the viewer terminal 20.

### Specific Example

Subsequently, a specific example of the second example embodiment will be described below with reference to FIG. 4. Further, in the following example, the advertisement distribution system 30 transmits different advertisement contents sent from the advertiser terminal 40 to the viewer terminal 20 a plurality of times.

First, the advertisement distributor and the viewer have the same account of the blockchain database 50. Therefore, the viewing certificate generation unit 11 causes the viewer terminal 20 and the advertisement distribution system 30, to form a channel for generating data locally with respect to the blockchain database 50.

Further, on the channel, the viewer terminal 20 and the advertisement distribution system 30 sign using the private key. The relationship between the viewer terminal 20 and its verification key, and the relationship between the advertisement distribution system 30 and its verification keys are guaranteed by the public key infrastructure respectively.

The advertisement distribution system 30 distributes a plurality of advertisement contents M to the viewer terminal 20. At this time, the advertisement distribution system transmits the advertisement ID (M_i) as an identifier for identifying the advertisement content, at the same time as the advertisement content M.

Then, the viewing certificate generation unit 11 selects one of the delivered advertisement contents. When the selected advertisement contents are viewed on the viewer terminal 20, The viewing certificate generation unit 11 causes the viewer terminal 20 to calculate the hash value M_H of the viewed advertisement content M. Further, when the hash value is calculated for the advertisement content that has been viewed earlier, the viewer terminal 20 combines the hash value calculated earlier and the hash value calculated this time to obtain the latest hash value M_H.

Further, in this case, the viewer terminal 20 sets the variable M_list in order to generate a list of the viewed advertisement contents, and sets M_List={M_i}. Then, the viewer terminal 20 generates the viewing certificate Proof_A with the hash values M_H, M_List, and the time information T that specifies the viewing time, and adds the digital signature to the viewing certificate Proof_A.

When the viewing certificate Proof_A is generated, the viewer terminal 20 adds the digital signature to the viewing certificate Proof_A, according to the instruction of the viewing certificate generation unit 11. Then the viewer terminal 20 transmits the viewing certificate Proof_A to the advertisement distribution system 30 via the channel. At this time, the viewer terminal 20 also transmits the variable Ver indicating the current version of the exchange on the channel to the advertisement distribution system 30 together with the viewing certification Proof_A.

When the viewing certification is transmitted, the advertisement distribution system 30 verifies the digital signature attached to the viewing certification by using the verification key. When the digital signature can be verified, the advertisement distribution system 30 adds a new digital signature to the viewing certification Proof_A and the variable Ver. by using its own private key possessed. Then, the advertisement distribution system 30 returns the viewing certification Proof_A and the variable Ver with the newly digital signature added via the channel.

The viewer terminal 20 repeats the generation and signature of the viewing certificate as long as the delivered advertising content is viewed. The advertisement distribution system 30 also repeats the signature as long as the delivered advertising content is viewed. Further, the viewing certification Proof_A and the variable Ver are updated each time. Then, at the timing when the viewer terminal 20 registers the viewing certification Proof_A and the variable Ver in the blockchain database 50, the viewer terminal 20 and the advertisement distribution system 30 close the channel. In this case, the latest versions of the viewing certification Proof_A and the variable Ver are registered in the blockchain database 50 with the signatures of the viewer terminal 20 and the advertisement distribution system 30 added.

After that, the advertiser verifies the signature of the latest version of the viewing certification Proof_A and the variable Ver registered in the blockchain database 50 by using the verification key of the viewer terminal 20 confirmed by the public key infrastructure via the advertiser terminal 40. The advertiser confirms that the advertisement content was actually viewed based on the verification result.

In the above-mentioned specific example, the viewing certification is collectively generated by forming the channel, but in the second example embodiment, the viewing certification may be collectively generated without forming the channel. Further, the number of settings described may be “1”. Further, the time information T may not be used for generating the viewing certificate. However, when the time information T is used, it is possible to prevent the viewing certificate from being reused.

[Program]

It is sufficient that the program according to the second example embodiment be a program that causes a computer to execute steps B1 to B14 illustrated in FIG. 4. The advertisement distribution guarantee apparatus and the advertisement distribution guarantee method according to the second example embodiment can be realized by installing this program in the computer and executing this program. In this case, a processor of the computer functions and performs processing as the viewing certificate generation unit 11 and the viewing certificate recording unit 12. Further, the computer in this case may be, for example, a computer constituting the viewer terminal or a computer different from the viewer terminal.

Also, the program according to the second example embodiment may be executed by a computer system constructed by a plurality of computers. In this case, for example, each computer may function as one of the viewing certificate generation unit 11 and the viewing certificate recording unit 12.

(Physical Configuration)

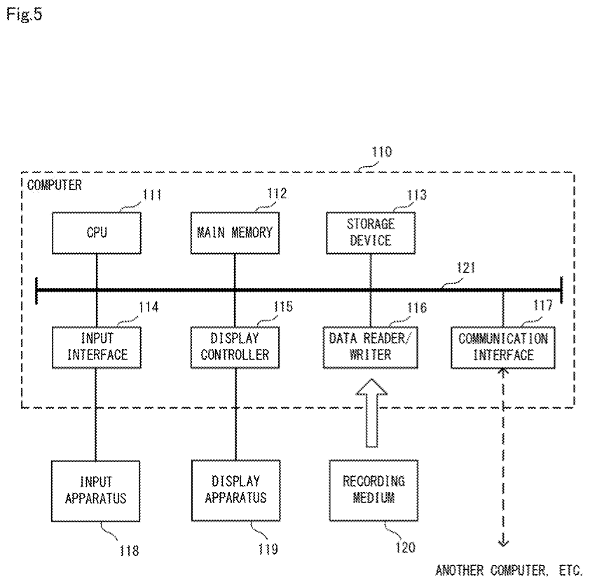

Using FIG. 5, a description is now given of the physical configuration of a computer that realizes the advertisement distribution guarantee apparatus by executing the program according to the first and second example embodiments. FIG. 5 is a block diagram illustrating an example of a computer that realizes the advertisement distribution guarantee apparatus according to the first and the second example embodiments.

As illustrated in FIG. 5, a computer 110 includes a CPU (Central Processing Unit) 111, a main memory 112, a storage device 113, an input interface 114, a display controller 115, a data reader/writer 116, and a communication interface 117. These components are connected in such a manner that they can perform data communication with one another via a bus 121. Note that the computer 110 may include a GPU (Graphics Processing Unit) or an FPGA (Field-Programmable Gate Array) in addition to the CPU 111 or in place of the CPU 111.

The CPU 111 carries out various types of computation by deploying the program (codes) according to the example embodiment stored in the storage device 113 to the main memory 112, and executing the deployed program in a predetermined order. The main memory 112 is typically a volatile storage device, such as a DRAM (Dynamic Random-Access Memory). Also, the program according to the first and second example embodiments is provided in a state where it is stored in a computer readable recording medium 120. Note that the program according to the present example embodiment may also be distributed over the Internet connected via the communication interface 117.

Furthermore, specific examples of the storage device 113 include a hard disk drive, and also a semiconductor storage device, such as a flash memory. The input interface 114 mediates data transmission between the CPU 111 and an input device 118, such as a keyboard and a mouse. The display controller 115 is connected to a display device 119, and controls displays on the display device 119.

The data reader/writer 116 mediates data transmission between the CPU 111 and the recording medium 120, and executes readout of the program from the recording medium 120, as well as writing of the result of processing in the computer 110 to the recording medium 120. The communication interface 117 mediates data transmission between the CPU 111 and another computer.

Also, specific examples of the recording medium 120 include: a general-purpose semiconductor storage device, such as CF (Compact Flash®) and SD (Secure Digital); a magnetic recording medium, such as Flexible Disk; and an optical recording medium, such as CD-ROM (Compact Disk Read Only Memory).

Note that the advertisement distribution guarantee apparatus according to the first to third example embodiments can also be realized by using items of hardware corresponding to respective components, rather than by using the computer with the program installed therein. Furthermore, a part of the advertisement distribution guarantee apparatus may be realized by the program, and the remaining part of the advertisement distribution guarantee apparatus may be realized by hardware.

A part or all of the aforementioned example embodiment can be described as, but is not limited to, the following (Supplementary note 1) to (Supplementary note 18).

(Supplementary Note 1)

An advertisement distribution guarantee apparatus, comprising:

a viewing certificate generation unit that causes a viewer terminal to generate a viewing certificate for a viewed advertisement content on condition that the advertisement content is viewed on the viewer terminal,

a viewing certificate recording unit makes the generated viewing certificate visible to the advertiser of the advertisement content and causes the viewer terminal to record the generated viewing certificate in a blockchain database.

(Supplementary Note 2)

The advertisement distribution guarantee apparatus according to Supplementary note 1, wherein

the viewing certificate generation unit generates a private key and a corresponding verification key, causes the viewer terminal to generate a digital signature using the private key, and to add the digital signature to the viewing certificate,

the viewing certificate recording unit that makes the verification key available to the advertiser and causes the viewer terminal to record the viewing certificate with the digital signature in the blockchain database.

(Supplementary Note 3)

The advertisement distribution guarantee apparatus according to Supplementary note 2, wherein

the viewing certificate generation unit causes the viewer terminal to generate the viewing certificate with the digital signature attached each time the single advertisement content is delivered,

the viewing certificate recording unit causes the viewer terminal to record the viewing certificate in the blockchain database, each time the single advertisement content is delivered.

(Supplementary Note 4)

The advertisement distribution guarantee apparatus according to Supplementary note 2, wherein

in the case where a plurality of the advertisement contents has been delivered, when any one of the advertisement contents is first viewed on the viewer terminal, the viewing certificate generation unit causes, for the advertisement content that was first viewed, the viewer terminal to generate the viewing certificate with the digital signature attached, and then, when the remaining advertisement content is viewed, causes the viewer terminal to update the viewing certificate each time viewing,

the viewing certificate recording unit causes, in the case where a plurality of the advertisement contents has been delivered, the viewer terminal to record the latest viewing certificate in the blockchain database.

(Supplementary Note 5)

The advertisement distribution guarantee apparatus according to Supplementary note 4, wherein

the viewing certificate generation unit transmits the viewing certificate with the digital signature to an advertisement distribution system that distributes the advertisement content each time the viewing certificate is generated or updated, and adds a digital signature by the advertisement distribution system to the transmitted viewing certificate,

the viewing certificate recording unit causes the viewer terminal to record the latest viewing certification with the digital signature added by both the viewer terminal and the advertisement distribution system in the blockchain database.

(Supplementary Note 6)

The advertisement distribution guarantee apparatus according to any of Supplementary notes 1 to 5, wherein

the advertisement distribution guarantee apparatus is constructed as a part of the viewer terminal,

in case that the advertisement content is displayed on the screen of the viewer terminal, the viewing certificate generation unit causes the viewer terminal to generate the viewing certificate, assuming that the advertisement content has been viewed.

(Supplementary Note 7)

An advertisement distribution guarantee method, comprising:

(a) causing a viewer terminal to generate a viewing certificate for a viewed advertisement content on condition that the advertisement content is viewed on the viewer terminal,

(b) making the generated viewing certificate visible to the advertiser of the advertisement content and causing the viewer terminal to record the generated viewing certificate in a blockchain database.

(Supplementary Note 8)

The advertisement distribution guarantee method according to Supplementary note 7, wherein

in the step (a), generating a private key and a corresponding verification key, causing the viewer terminal to generate a digital signature using the private key, and to add the digital signature to the viewing certificate,

in the step (b), making the verification key available to the advertiser and causing the viewer terminal to record the viewing certificate with the digital signature in the blockchain database.

(Supplementary Note 9)

The advertisement distribution guarantee method according to Supplementary note 8, wherein

in the step (a), causing the viewer terminal to generate the viewing certificate with the digital signature attached each time the single advertisement content is delivered,

in the step (b), causing the viewer terminal to record the viewing certificate in the blockchain database, each time the single advertisement content is delivered.

(Supplementary Note 10)

The advertisement distribution guarantee method according to Supplementary note 8, wherein

in the step (a), in the case where a plurality of the advertisement contents has been delivered, when any one of the advertisement contents is first viewed on the viewer terminal, causing, for the advertisement content that was first viewed, the viewer terminal to generate the viewing certificate with the digital signature attached, and then, when the remaining advertisement content is viewed, causing the viewer terminal to update the viewing certificate each time viewing,

in the step (b), causing, in the case where a plurality of the advertisement contents has been delivered, the viewer terminal to record the latest viewing certificate in the blockchain database.

(Supplementary Note 11)

The advertisement distribution guarantee method according to Supplementary note 10, wherein

in the step (a), transmitting the viewing certificate with the digital signature to an advertisement distribution system that distributes the advertisement content each time the viewing certificate is generated or updated, and adding a digital signature by the advertisement distribution system to the transmitted viewing certificate,

in the step (b), causing the viewer terminal to record the latest viewing certification with the digital signature added by both the viewer terminal and the advertisement distribution system in the blockchain database.

(Supplementary Note 12)

The advertisement distribution guarantee method according to any of Supplementary notes 7 to 11, wherein

the advertisement distribution guarantee method is executed by the viewer terminal,

in the step (a), in case that the advertisement content is displayed on the screen of the viewer terminal, causing the viewer terminal to generate the viewing certificate, assuming that the advertisement content has been viewed.

(Supplementary Note 13)

A computer readable recording medium that includes a program recorded thereon, the program including instructions that cause a computer to carry out:

(a) a step of causing a viewer terminal to generate a viewing certificate for a viewed advertisement content on condition that the advertisement content is viewed on the viewer terminal,

(b) a step of making the generated viewing certificate visible to the advertiser of the advertisement content and causing the viewer terminal to record the generated viewing certificate in a blockchain database.

(Supplementary Note 14)

The computer readable recording medium according to Supplementary note 13, wherein

in the step (a), generating a private key and a corresponding verification key, causing the viewer terminal to generate a digital signature using the private key, and to add the digital signature to the viewing certificate,

in the step (b), making the verification key available to the advertiser and causing the viewer terminal to record the viewing certificate with the digital signature in the blockchain database.

(Supplementary Note 15)

The computer readable recording medium according to Supplementary note 14, wherein

in the step (a), causing the viewer terminal to generate the viewing certificate with the digital signature attached each time the single advertisement content is delivered,

in the step (b), causing the viewer terminal to record the viewing certificate in the blockchain database, each time the single advertisement content is delivered.

(Supplementary Note 16)

The computer readable recording medium according to Supplementary note 14, wherein

in the step (a), in the case where a plurality of the advertisement contents has been delivered, when any one of the advertisement contents is first viewed on the viewer terminal, causing, for the advertisement content that was first viewed, the viewer terminal to generate the viewing certificate with the digital signature attached, and then, when the remaining advertisement content is viewed, causing the viewer terminal to update the viewing certificate each time viewing,

in the step (b), causing, in the case where a plurality of the advertisement contents has been delivered, the viewer terminal to record the latest viewing certificate in the blockchain database.

(Supplementary Note 17)

The computer readable recording medium according to Supplementary note 16, wherein

in the step (a), transmitting the viewing certificate with the digital signature to an advertisement distribution system that distributes the advertisement content each time the viewing certificate is generated or updated, and adding a digital signature by the advertisement distribution system to the transmitted viewing certificate,

in the step (b), causing the viewer terminal to record the latest viewing certification with the digital signature added by both the viewer terminal and the advertisement distribution system in the blockchain database.

(Supplementary Note 18)

The computer readable recording medium according to any of Supplementary notes 13 to 17, wherein

the computer is included in the viewer terminal,

in the step (a), in case that the advertisement content is displayed on the screen of the viewer terminal, causing the viewer terminal to generate the viewing certificate, assuming that the advertisement content has been viewed.

The invention has been described with reference to an example embodiment above, but the invention is not limited to the above-described example embodiment. Within the scope of the invention, various changes that could be understood by a person skilled in the art could be applied to the configurations and details of the invention.

### INDUSTRIAL APPLICABILITY

As described above, according to the present invention, it is possible to enable the advertiser to confirm the advertisement viewing history while suppressing the falsification of the advertisement viewing history in the distribution of the advertisement content on the Web. The present invention is useful in the distribution of advertisements on the Web.

### REFERENCE SIGNS LIST

10 advertisement distribution guarantee apparatus
11 viewing certificate generation unit
12 viewing certificate recording unit
20 viewer terminal
30 advertisement distribution system
40 advertiser terminal
50 blockchain database
110 computer
111 CPU
112 main memory
113 storage device
114 input interface
115 display controller
116 data reader/writer
117 communication interface
118 input apparatus
119 display apparatus
120 recording medium
121 bus

What is claimed is:

1. An advertisement distribution guarantee apparatus, comprising:
at least one memory storing instructions; and
at least one processor configured to execute the instructions to:
cause a viewer terminal to generate a viewing certificate for a viewed advertisement content on condition that the advertisement content is viewed on the viewer terminal,
make the generated viewing certificate visible to the advertiser of the advertisement content and cause the viewer terminal to record the generated viewing certificate in a blockchain database.

2. The advertisement distribution guarantee apparatus according to claim 1, wherein, further at least one processor configured to execute the instructions to:
generate a private key and a corresponding verification key, cause the viewer terminal to generate a digital signature using the private key, and to add the digital signature to the viewing certificate,
make the verification key available to the advertiser and cause the viewer terminal to record the viewing certificate with the digital signature in the blockchain database.

3. The advertisement distribution guarantee apparatus according to claim 2, wherein, further at least one processor configured to execute the instructions to:
cause the viewer terminal to generate the viewing certificate with the digital signature attached each time the single advertisement content is delivered,
cause the viewer terminal to record the viewing certificate in the blockchain database, each time the single advertisement content is delivered.

4. The advertisement distribution guarantee apparatus according to claim 2, wherein, further at least one processor configured to execute the instructions to:
in the case where a plurality of the advertisement contents has been delivered, when any one of the advertisement contents is first viewed on the viewer terminal, cause, for the advertisement content that was first viewed, the viewer terminal to generate the viewing certificate with the digital signature attached, and then, when the remaining advertisement content is viewed, cause the viewer terminal to update the viewing certificate each time viewing,
cause, in the case where a plurality of the advertisement contents has been delivered, the viewer terminal to record the latest viewing certificate in the blockchain database.

5. The advertisement distribution guarantee apparatus according to claim 4, wherein, further at least one processor configured to execute the instructions to:
transmit the viewing certificate with the digital signature to an advertisement distribution system that distributes the advertisement content each time the viewing certificate is generated or updated, and adds a digital signature by the advertisement distribution system to the transmitted viewing certificate,
cause the viewer terminal to record the latest viewing certification with the digital signature added by both the viewer terminal and the advertisement distribution system in the blockchain database.

6. The advertisement distribution guarantee apparatus according to claim 1, wherein
the advertisement distribution guarantee apparatus is constructed as a part of the viewer terminal,
further at least one processor configured to execute the instructions to:
in case that the advertisement content is displayed on the screen of the viewer terminal, cause the viewer terminal to generate the viewing certificate, assuming that the advertisement content has been viewed.

7. An advertisement distribution guarantee method, comprising:
causing a viewer terminal to generate a viewing certificate for a viewed advertisement content on condition that the advertisement content is viewed on the viewer terminal,
making the generated viewing certificate visible to the advertiser of the advertisement content and causing the viewer terminal to record the generated viewing certificate in a blockchain database.

8. A non-transitory computer readable recording medium that includes a program recorded thereon, the program including instructions that cause a computer to carry out:
a step of causing a viewer terminal to generate a viewing certificate for a viewed advertisement content on condition that the advertisement content is viewed on the viewer terminal,
a step of making the generated viewing certificate visible to the advertiser of the advertisement content and causing the viewer terminal to record the generated viewing certificate in a blockchain database.

9. The advertisement distribution guarantee method according to claim 7, wherein
generating a private key and a corresponding verification key, causing the viewer terminal to generate a digital signature using the private key, and to add the digital signature to the viewing certificate,
making the verification key available to the advertiser and causing the viewer terminal to record the viewing certificate with the digital signature in the blockchain database.

10. The advertisement distribution guarantee method according to claim 9, wherein
causing the viewer terminal to generate the viewing certificate with the digital signature attached each time the single advertisement content is delivered,
causing the viewer terminal to record the viewing certificate in the blockchain database, each time the single advertisement content is delivered.

11. The advertisement distribution guarantee method according to claim 9, wherein
in the case where a plurality of the advertisement contents has been delivered, when any one of the advertisement contents is first viewed on the viewer terminal, causing, for the advertisement content that was first viewed, the viewer terminal to generate the viewing certificate with the digital signature attached, and then, when the remaining advertisement content is viewed, causing the viewer terminal to update the viewing certificate each time viewing,
causing, in the case where a plurality of the advertisement contents has been delivered, the viewer terminal to record the latest viewing certificate in the blockchain database.

12. The advertisement distribution guarantee method according to claim 11, wherein
transmitting the viewing certificate with the digital signature to an advertisement distribution system that distributes the advertisement content each time the viewing certificate is generated or updated, and adding a digital signature by the advertisement distribution system to the transmitted viewing certificate,
causing the viewer terminal to record the latest viewing certification with the digital signature added by both the viewer terminal and the advertisement distribution system in the blockchain database.

13. The advertisement distribution guarantee method according to claim 7, wherein
the advertisement distribution guarantee method is executed by the viewer terminal,
in case that the advertisement content is displayed on the screen of the viewer terminal, causing the viewer terminal to generate the viewing certificate, assuming that the advertisement content has been viewed.

14. The non-transitory computer readable recording medium according to claim 8, wherein
generating a private key and a corresponding verification key, causing the viewer terminal to generate a digital signature using the private key, and to add the digital signature to the viewing certificate,
making the verification key available to the advertiser and causing the viewer terminal to record the viewing certificate with the digital signature in the blockchain database.

15. The non-transitory computer readable recording medium according to claim 14, wherein
causing the viewer terminal to generate the viewing certificate with the digital signature attached each time the single advertisement content is delivered,
causing the viewer terminal to record the viewing certificate in the blockchain database, each time the single advertisement content is delivered.

16. The non-transitory computer readable recording medium according to claim 14, wherein
in the case where a plurality of the advertisement contents has been delivered, when any one of the advertisement contents is first viewed on the viewer terminal, causing, for the advertisement content that was first viewed, the viewer terminal to generate the viewing certificate with the digital signature attached, and then, when the remaining advertisement content is viewed, causing the viewer terminal to update the viewing certificate each time viewing,
causing, in the case where a plurality of the advertisement contents has been delivered, the viewer terminal to record the latest viewing certificate in the blockchain database.

17. The non-transitory computer readable recording medium according to claim 16, wherein
transmitting the viewing certificate with the digital signature to an advertisement distribution system that distributes the advertisement content each time the viewing certificate is generated or updated, and adding a digital signature by the advertisement distribution system to the transmitted viewing certificate,
causing the viewer terminal to record the latest viewing certification with the digital signature added by both the viewer terminal and the advertisement distribution system in the blockchain database.

18. The non-transitory computer readable recording medium according to claim 8, wherein
the computer is included in the viewer terminal,
in case that the advertisement content is displayed on the screen of the viewer terminal, causing the viewer terminal to generate the viewing certificate, assuming that the advertisement content has been viewed.
